(19) United States
(12) Patent Application Publication
(10) Pub. No.: US 2005/0229988 A1
(43) Pub. Date: Oct. 20, 2005

(54) Stretchable fabric cover for hoses and means for securing

(76) Inventor: Alfredo Asta, Woodbridge (CA)

Correspondence Address: Michael S. Leonard;EVEREST INTELLECTUAL PROPERTY LAW GROUP, P.O. Box 708, Northbrook, IL, 60065, US

(21) Appl. No.: 11/106,805

(22) Filed: Apr. 15, 2005

(30) Foreign Application Priority Data
Apr. 15, 2004 (CA) 2,464,564

(51) Int. Cl. F16L 11/00

(52) U.S. Cl. 138/110; 138/103; 138/106

(57) ABSTRACT

A stretchable fabric cover for a hose, and a coupling and an adjustable strap for securing a cover to a hose are provided. The stretchable fabric cover comprises a tubular member formed of a non-abrasive fabric being open at opposite ends thereof. The non-abrasive fabric includes elastic fibers allowing lateral and longitudinal stretching of the tubular member in response to a corresponding lateral or longitudinal stretching force. Other embodiments are also provided.

### FIELD OF THE INVENTION

The present invention relates to a stretchable fabric cover and means for securing a cover to a hose, and more particularly to a stretchable fabric cover for a vacuum hose and means for securing the cover thereto.

### BACKGROUND OF THE INVENTION

Many appliances have cords (e.g. electrical cords), hoses or cables that may contact furniture, walls, floors or other surfaces. These cords or cables may mark, scratch or otherwise damage the surfaces which they contact. For example, automotive and floor polishers have electrical cords that may scratch the surfaces being polished. Central vacuum systems have a vacuum hose that is typically made of plastic, and often have corrugations for imparting strength and flexibility to the hose. These corrugations can scratch and abrade furniture or other surfaces as the hose is moved.

Tubular covers for hoses and electrical cords made of non-abrasive materials have been made for some time to address this problem. A known tubular cover or sleeve for a surface polisher comprises a tubular member having an internal diameter larger than the diameter of the electrical cord to be covered. A longitudinal slit in the sleeve provides for installation and removal of the sleeve. An example of this type of sleeve is disclosed in U.S. Pat. No. 4,899,414, issued Feb. 13, 1990. A disadvantage of this type of sleeve is that it can slip off the electrical cord through the slit. Another disadvantage is that it only loosely covers the cord allowing it to slip up and down at its respective ends.

Another known tubular cover for a vacuum hose uses means at each end of the sleeve (e.g. a tape fastener) to secure it to the hose. An example of this type of sleeve is disclosed in U.S. Pat. No. 5,095,576, issued Mar. 17, 1992. During installation, the cover must be extended over the end plug and handle of the vacuum hose. Generally, this requires a hose cover having a diameter larger than that of the end plug and handle, resulting in a hose cover which is somewhat loose fitting about the circumference of the hose and therefore suffers from all of the drawbacks which follow from that condition, such as end slippage, bunching and spot wear.

Another known tubular cover, invented by the present inventor and disclosed in U.S. Pat. No. 5,651,161, issued Jul. 29, 1997, provides a fabric cover for a vacuum hose which comprises an elongate rectangular piece of fabric having a width approximately corresponding to the circumference of the hose and having parallel longitudinal edges. The cover has fastening means for securing it about the hose which are attached along each longitudinal edge so that upon securing the cover about the hose, the fastening means are covered by abutting longitudinal edges of the cover. While effective at reducing surface damage and providing ease of installation and removal, end slippage may still occur with this type of hose cover.

In view of the foregoing, it is apparent that the known tubular covers described above have only a limited ability to flex in response to any expansion of the hose being covered (e.g., a corrugated hose), or any twisting and turning of the hose. As a result, end slippage and bunching remain a problem with hose covers.

### SUMMARY OF THE INVENTION

The present invention provides a stretchable fabric cover for a hose or cord which protects surfaces from scratching, marking and similar damage. The cover is capable of lateral stretching for ease of installation and removal, and longitudinal stretching in response to any expansion of the hose, or any twisting and turning of the hose. The present invention also provides a coupling and an adjustable strap for securing a cover to a hose.

According to one aspect of the present invention, there is provided a stretchable fabric cover for a hose. The stretchable fabric cover comprises a tubular member formed of a non-abrasive fabric being open at opposite ends thereof. The non-abrasive fabric includes elastic fibers allowing lateral and longitudinal stretching of the tubular member in response to a corresponding lateral or longitudinal stretching force.

According to a further aspect of the present invention, there is provided a coupling for use in combination with a tubular cover for a hose, the cover being open at opposite ends thereof, the hose to be received within the cover, a coupling for each of the opposite ends of the cover for securing the cover the hose. The coupling comprises an inner ring having inner and outer surfaces, the inner surface defining a central passage for receiving the cover and hose; and an outer ring having an inner surface defining a central passage for receiving the inner ring.

According to another aspect of the present invention, there is provided a strap for securing a cover to a hose, comprising: an elongate flexible member for wrapping about a circumference of the hose, the flexible member including a belt and an adjacent main portion for releasably securing the belt therein, the belt having an inner portion and an outer portion adjacent to the inner portion, the inner portion including a plurality of spaced apart locking projections, an inner surface of the main portion including a plurality of spaced apart first projections for releasably engaging the locking projections of the belt.

According to yet a further aspect of the present invention, there is provided a method for securing a tubular cover to a hose, the cover being open at opposite ends thereof, comprising the steps of: applying a lateral stretching force to one end of the cover to enlarge its diameter so as to be larger than the diameter of the hose; introducing the hose into the enlarged end of the cover; and aligning the opposite ends of the cover with the respective ends of the hose.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 is a schematic view of a stretchable fabric cover for a vacuum hose;

FIG. 2 is a perspective view of terry knit fibers in the cover of FIG. 1;

FIG. 3 is a perspective view of an outer ring of the coupling for the cover of FIG. 1;

FIG. 4 is a perspective view of an inner ring of the coupling for the cover of FIG. 1;

FIG. 5 is a top view of the outer ring of FIG. 3;

FIG. 6 is a top view of the inner ring of FIG. 4;

FIG. 7 is a side view of the inner ring of FIG. 4;

FIG. 8 is a rear view of the inner ring of FIG. 4;

FIG. 9 is a fragmentary, partial, side view of the cover of FIG. 1 showing helical corrugations in the vacuum hose;

FIG. 10 is a sectional view of the cover of FIG. 9 showing the inner ring of FIG. 4 and outer ring of FIG. 3 positioned to secure the cover to the vacuum hose;

FIG. 11 is a sectional view of the cover of FIG. 10 with the inner ring secured to the cover and vacuum hose;

FIG. 12 is a top view of one embodiment of a strap for securing the cover of FIG. 1;

FIG. 13 is a sectional view of the strap of FIG. 12 taken along the line 13-13;

FIG. 14 is a bottom view of the strap of FIG. 12;

FIG. 15 is a perspective view of the strap of FIG. 12;

FIG. 16 is a perspective view of a cover on an installation tube; and

FIG. 17A to 17F are schematic representations illustrating one method of installing a cover using the strap of FIG. 12.

Similar references are used in different figures to denote similar components.

### DETAILED DESCRIPTION OF THE DRAWINGS

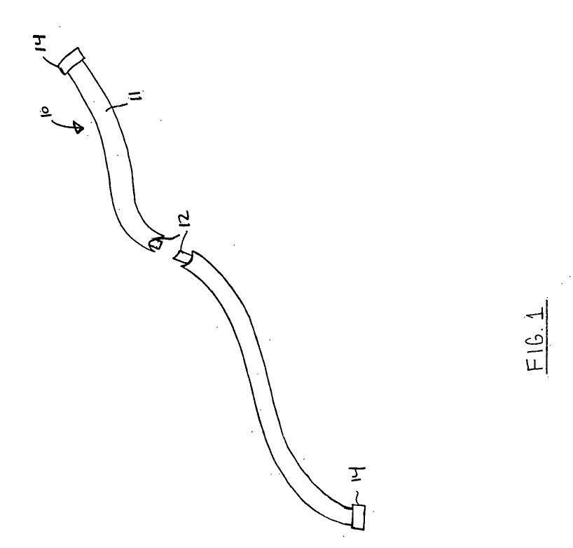

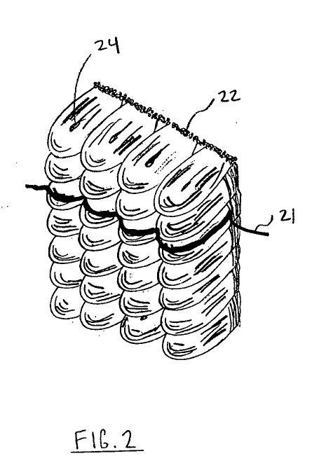

Referring now to FIG. 1, a stretchable fabric cover 10 for a vacuum hose 12 will be described. The cover 10 has a generally tubular shape and comprises a hollow tubular member formed of a non-abrasive fabric 11 being open at opposite ends thereof. The non-abrasive fabric 11 comprises elastic fibers 21 (FIG. 2) allowing lateral and longitudinal stretching of the hollow tubular member in response to a corresponding lateral or longitudinal stretching force. The cover 10 is releasably secured to the vacuum hose 12 at its opposite ends using a strap 100, coupling 14 or other releasable securing means. Other securing means may also be used to releasably secure the cover 10 to the vacuum hose 12, for example releasable ties such as nylon cable ties from Gardiner Bender (Milwaukee, Wis.), drawstrings, hose clamps or other suitable clamping means. While not illustrated here, the vacuum hose 12 has a plug end having a plug for connecting to a vacuum (e.g., a central vacuum system or standalone vacuum), and a handle end having a handle for connecting to a vacuum accessory such as a beater brush, power brush or wand.

The non-abrasive fabric 11 comprises a blend of elastic and non-elastic fibers, however the non-abrasive fabric 11 may be formed entirely of a suitable elastic fiber if desired. The term non-abrasive is used in the sense that the fabric 11, relative to other fabrics, will not cause significant marking, scratching or abrasion of the surfaces it contacts. The elastic fibers 21 provide a degree of stretch to the fabric 11. The elastic fibers 21 are typically selected to withstand dyeing, bleaching, mercerizing, and garment washing conditions without a significant loss of stretch performance. In some embodiments, the elastic fibers comprise Lycra™ fibers manufactured by DuPont (Wilmington, Del., USA). The particular type of Lycra™ fiber suitable for a particular application can be readily determined by persons skilled in the art. Other suitable elastic fibers that may be used include DOW XLA™ fibers from The Dow Chemical Company (Midland, Mich., USA), fibers sold under the generic name Spandex or Elastane, rubber, or other suitable stretchable fiber or yarn. The quantity of elastic fibers in the fabric 11 may be varied to increase or decrease the elastic (stretch) performance of the cover 10. The specific amount of elastic fibers in the fabric 11 can be readily determined by persons skilled in the art.

In some embodiments, the fabric 11 comprises between 5 percent and 30 percent Lycra™ fibers by weight. At 5 percent Lycra™ fibers, suitable stretch performance is exhibited by the cover 10 for most applications. Above 30 percent Lycra™ fibers, the cost of manufacturing the cover 10 may become significant due to the relatively high expense of the elastic fibers. In one embodiment, the fabric 11 comprises approximately 14.9 percent Lycra™ fibers and approximately 85.1 percent polyester fibers. In other embodiments, the fabric 11 comprises approximately 18 percent Lycra™ fibers and the balance polyester fibers.

Polyester fibers are preferable for the non-elastic fibers because they are generally less expensive than other non-elastic fibers, however the non-elastic fibers may be any suitable natural or synthetic yarn or fiber. For example, the non-elastic elastic fibers may be cotton, acrylic, polyester, or blends thereof provided the resultant fabric 11 provides the desired stretch performance. It will be appreciated that the non-elastic fibers may have some inherent elasticity, but as compared to the elastic fibers 21, have no useful elasticity. The non-elastic fibers may be selected for physical properties such as, for example, strength, durability, colour or other preferences of the user of the cover 10.

The fabric 11 may be either knit or woven provided the resultant fabric 11 provides the desired stretch performance. The preferred fabric 11 for the cover 10 is a knitted fabric, which may be a terry knit cloth (commonly referred to as “terry cloth”). A terry knit fabric generally comprises uncut loops of thread on one or both sides of the fabric, often grouped into piles of such loops. In some embodiments, the non-abrasive fabric 11 is a terry knit non-abrasive fabric 11 comprising a fabric surface 22 and a plurality of terry loops 24 extending from the fabric surface 22 as shown in FIG. 2. The terry loops 24 provide cushioning for the cover 10. The terry loops 24 may be on the inside or outside of the cover 10. The use of terry loops 24 on the inside of the cover 10 may reduce the chance of the fabric 11 catching on an object when the vacuum hose 12 is moved. Because of the tubular nature of the cover 10, the cover 10 can be reversed by turning the fabric 11 inside out. It will be apparent to persons skilled in the art that other types of knitting may also be used including rib knit, lacoste knit, jersey knit, full terry and half terry knits, and certain variations and modifications thereof.

The hollow tubular member has a relaxed state in which no stretching force is applied to the cover 10, and an extended state in which one or both of a lateral or longitudinal stretching force is applied to the cover 10. In some embodiments of the cover 10, in its relaxed state, the hollow tubular member has a diameter less than the diameter of the vacuum hose 12. During installation, a lateral or radial stretching force is applied to the cover 10 to expand its diameter. For a typical central vacuum hose of 1¼ to 1⅜ inch diameter, the cover 10 may be stretched to a diameter of 3 inches or more so that the cover 10 can be fit over the vacuum hose 12 as well as the end plug and/or handle at its respective ends. The expanded diameter allows the vacuum hose 12 to be introduced into one of the open ends of the cover 10. When the lateral stretching force is released, the cover 10 will snuggly fit the vacuum hose 12.

In some embodiments of the cover 10, in its relaxed state, the hollow tubular member may have a length less than the length of the vacuum hose 12 so that when a longitudinal stretching force is applied to the cover 10 it can be stretched to the opposite ends of the vacuum hose 12 and secured thereto while the elastic fibers 21 retain sufficient elasticity for further longitudinal stretching of the hollow tubular member. When installing the cover 10, the cover 10 may be secured within recesses (e.g., corrugations) defined by the vacuum hose 12 near the opposite ends thereof.

The use of non-elastic thread or yarn such as cotton, polyester or a blend thereof to make a woven or knitted fabric for a hose cover results in a cover which has no useful elasticity. Accordingly, covers made of such materials require additional structure for securing about a vacuum hose. In contrast to conventional covers, the cover 10 comprises elastic fibers which allow lateral stretching of the cover 10 so that the diameter of cover 10 can be expanded. The cover 10 can then be fit over the vacuum hose 12 and secured at opposite ends thereof, providing ease of installation and removal of the cover 10. The elastic fibers also allow the cover 10 to stretch longitudinally in response to any expansion (flex) of the vacuum hose 12, or any twisting and turning of the vacuum hose 12, thereby reducing end slippage.

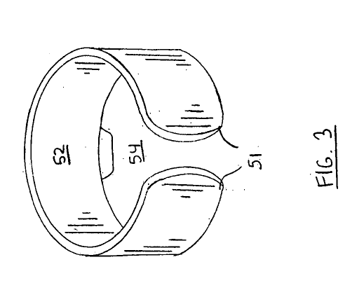

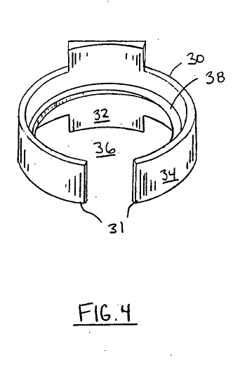

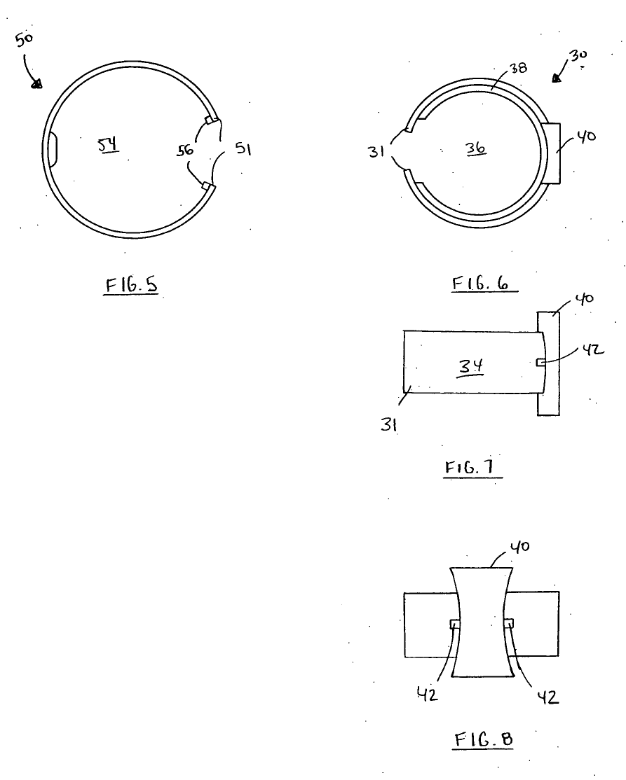

Referring now to FIG. 3 to 8, one embodiment of the coupling 14 will be described. The coupling 14 is a multi-part coupling comprising an inner ring 30 (FIG. 4) and outer ring 50 (FIG. 3) both formed of a flexible, resilient material. For example, the coupling 14 may be formed out of a flexible polyvinylchloride (PVC) polymer or equivalents thereof provided the coupling 14 has the necessary resiliency. The inner ring 30 comprises a central portion or abutting member 40 and resilient opposed members 31 extending therefrom. The inner ring 30 also has an inner surface 32 and outer surface 34. The inner surface 32 defines a central passage 36 for receiving the cover 10 and vacuum hose 12 therein. Recesses 42 are defined in the outer surface 34. In the shown embodiment, the recesses 42 are defined towards the location where the opposed members 31 meet the abutting member 40 at the rear of the inner ring 30.

In the shown embodiment, the central passage 36 of the inner ring 30 has a diameter slightly less than the external diameter of the vacuum hose 12, for example 1 1/2 inches. In other embodiments, the inner ring 30 may have a diameter slightly greater than or roughly equivalent to the external diameter of the vacuum hose 12. The inner ring 30 also includes an engaging member 38, for example a concentric ridge on at least a portion of the inner surface 32, for engaging a corrugation 13 in the vacuum hose 12. As will be appreciated by persons skilled in the art, the corrugations 13 comprise a series of alternating ridges and grooves (or recesses). Many different patterns and styles of vacuum hose corrugations are known in the art.

As shown in FIG. 4, the concentric ridge transverses the inner surface 32 of the inner ring 30 along a helical path corresponding to the helical shape of the corrugations 13 in the vacuum hose 12. The shape and orientation of the engaging member 38 may be varied provided it is adapted to engage one or more corrugations in the hose, for example the engaging member 38 may have a circular path on the inner surface 32 for engaging a circular corrugation on a vacuum hose. Thus, it will be appreciated that the coupling 14 may be adapted for securing the cover 10 to all types of corrugated hoses and other types of hoses having recesses defined towards the opposite ends thereof. In other embodiments, the coupling 14 may not include an engaging member 38, for example if an electrical cord or non-corrugated vacuum hose is to be covered.

The outer ring 50 comprises resilient opposed members 51 and has an inner surface 52 defining a central passage 54 for receiving the inner ring 30. The inner surface 52 of the outer ring 54 also includes projections 56 for engaging the recesses 42 of the inner ring 30. As shown in FIG. 5, in the shown embodiment, the projections 56 are located towards the ends of the opposed members 51. The central passage 54 is sized and configured to releasably engage the inner ring 30. In this embodiment, the central passage 54 has a diameter slightly smaller than the external diameter of the inner ring 30.

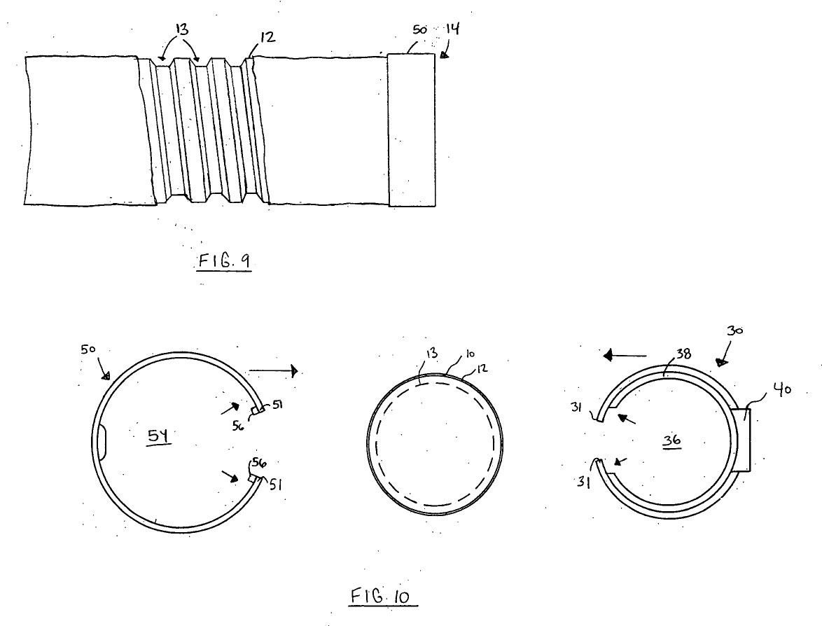

Referring now to FIG. 9 to 11, a method for securing the cover 10 to the vacuum hose 12 will be described. First, the diameter of the cover 10 at one end is enlarged to fit over the vacuum hose 12 as well as the end plug and/or handle at its respective ends. The elastic fibers 21 allow the cover 10 to be stretched to the required diameter, e.g., 3 inches for a standard central vacuum hose. The vacuum hose 12 is then introduced through the enlarged end of the cover 10. The opposite ends of the cover 10 are then aligned with the respective ends of the vacuum hose 12. When the lateral stretching force used to increase the diameter of the cover 10 is released, the cover 10 will snuggly fit the vacuum hose 12. Aligning the cover 10 with the ends of the vacuum hose 12 may require longitudinal stretching of the cover 10.

Next, the inner ring 30 is secured within a corrugation 13 of the vacuum hose 12 (now covered by the cover 10) near one of the opposite ends of the vacuum hose 12. To secure the inner ring 30 to the hose 12, the opposed members 31 of the inner ring 30 are spread apart and fit over the hose-cover combination near one of its opposite ends. The inner ring 30 is then pressed into contact with the cover 10 and hose 12 such that the engaging member 38 engages a corrugation 13 in the hose 12 as shown in FIG. 11. In this manner, the engaging member 38 secures the cover 10 with the corrugation 13. After the spreading force is removed, the resilient nature of the inner ring 30 causes the opposed members 31 to exert a small clamping force on the hose 12.

The size of the central passage 36 and the engaging member 38 provide for the inner ring 30 to be releasably secured to the hose 12. However, the inner ring 30 alone may not be sufficient to secure the cover 10 to the hose 12 to withstand the forces exerted on the hose 12 during normal use. The outer ring 50 is secured to the inner ring 30 to provide additional security of attachment. To secure the outer ring 50 to the inner ring 30, the opposed members 51 are spread apart and fit over the inner ring 30 such that the abutting member 40 is held between the ends of the opposed members 51. The resilient nature of the outer ring 50 causes the opposed members 51 to attempt to return to their original shape and position after the spreading force is released. However, because the external diameter of the inner ring 30 is larger than the diameter of the central passage 54, the opposed members 51 cannot fully return to their original state. As a result, the opposed members 51 exert a peripheral clamping force on the inner ring 30 further securing it to the hose 12. Additionally, the projections 56 of the outer ring 50 may be received in the recesses 42 of the inner ring 30 providing further security of attachment. This procedure is then repeated for the opposite end of the vacuum hose.

Many variations of a coupling for releasably securing the hose are possible. In some embodiments, the coupling may include an inner clip or ring shaped to at least partially surround the hose and define a groove (e.g., concentric groove) on the outer surface thereof for receiving an outer clip or ring. The groove defined by the inner clip and the shape of the outer clip may be selected for releasably securing the outer clip to the inner clip (e.g., using resilient properties of the clips), eliminating the need for mating projections and recesses for engaging the clips described above. Other means for releasably engaging the inner and outer clips may also be used.

The inner clip may be releasably secured to a hose using one or more projections, such as teeth, provided on an inner surface thereof. One or both of the inner and outer clips may comprise two half clips or clam shells which may be connected along an integral hinge. In some embodiments, the inner clip may be installed on the hose towards its respective ends before the cover is installed. The fabric cover is then installed over the inner clip, and the outer clip is attached to the inner clip over top of the hose cover. Excess fabric from the hose cover may then be folded back to cover the outer clip. In other embodiments, the inner and outer clips are installed after the hose cover similar to the method described above.

According to the present invention, there is provided a coupling for use in combination with a tubular cover for a hose (e.g., vacuum hose), the cover being open at opposite ends thereof, the vacuum hose to be received within the cover, a coupling for each of the opposite ends of the cover for securing the cover the vacuum hose. The coupling comprising: an inner ring having inner and outer surfaces, the inner surface defining a central passage for receiving the cover and vacuum hose; and an outer ring having an inner surface defining a central passage for receiving the inner ring.

In some embodiments, the inner ring includes at least one engaging member for engaging a corrugation in the vacuum hose.

In some embodiments, the engaging member is a projection, protrusion, protuberance, tooth, or ridge (e.g., concentric ridge) on at least a portion of the inner surface of the inner ring. In some embodiments, the engaging member is a concentric ridge that transverses the inner surface of the inner ring along a helical path corresponding to the corrugation in the vacuum hose.

In some embodiments, the inner ring comprises a central portion and a pair of opposed members for engaging the vacuum hose extending from the central portion, the outer ring comprising a pair of opposed members for releasably engaging the outer surface of the inner ring.

In some embodiments, the outer surface of the inner ring defines recesses near the central portion, the inner surface of the outer ring including projections near the ends of its opposed members for releasably engaging the recesses of the inner ring, the ends of the opposed members of the outer ring engaging the inner ring about the central portion.

In some embodiments, the central passage of the outer ring has a diameter less than the external diameter of the inner ring.

In some embodiments, the inner ring and outer ring are formed of a flexible, resilient material.

The coupling of the present invention may be used with different types of covers, including stretchable hose covers, non-stretchable hose covers, fabric and non-fabric hose covers. In some embodiments, the coupling may be used with different types of hoses and cords, including corrugated and non-corrugated hoses and cords.

According to the present invention, there is also provided a method for securing a tubular cover to a hose (e.g., vacuum hose), the cover being made of a stretchable fabric and being open at opposite ends thereof, comprising the steps of: applying a lateral stretching force to one end of the cover to enlarge its diameter so as to be larger than the diameter of the vacuum hose; introducing the vacuum hose into the enlarged end of the cover; aligning the opposite ends of the cover with the respective ends of the vacuum hose; and securing the opposite ends of the cover to the vacuum hose.

In some embodiments, the step of aligning the opposite ends of the cover includes the step of applying a longitudinal stretching force to the cover to increase the length of the cover so that its ends are aligned with the opposite ends of the vacuum hose.

In some embodiments, the step of securing the opposite ends of the cover comprises the step of securing the cover within recesses defined in the vacuum hose near the opposite ends of the vacuum hose.

In some embodiments, the cover is secured within recesses defined by corrugations in the vacuum hose.

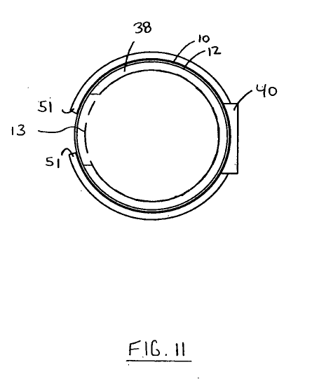

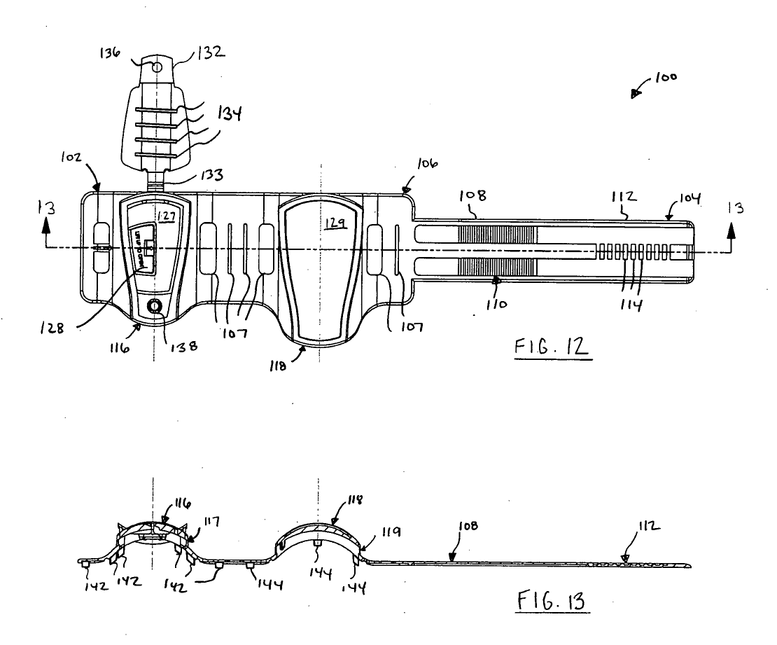

Referring to FIG. 12 to 15, one embodiment of an adjustable strap 100 for releasably securing a hose cover, such as a stretchable fabric hose cover 10, will now be,described. The strap 100 comprises an elongate flexible member 102 having a flexible belt 104 and an adjacent main portion 106 for wrapping about the circumference of the hose 12. The belt 104 has an inner portion 108 including a plurality of spaced apart locking projections 110 and an outer portion 112 adjacent to the inner portion 106 which defines a plurality of spaced apart holes or slots 114. The locking projections 110 provide multiple locking positions for the belt 104 as will be described in more detail below. In some embodiments, the strap 100 is made of a flexible Nylon™ material and may be formed by injection molding. The belt 104 and/or the main portion 106 may be provided with a series of slots or cut outs 107 to increase the flexibility of the strap 100. The size, number and configuration of the slots 107 may be selected to maximize the flexibility and durability of the strap 100.

The main portion 106 includes adjacent first and second portions indicating by references 116 and 118 respectively. In the shown embodiment the first and second portions 116, 118 form enlarged, outwardly extending portions that are shaped (e.g., curved) to generally correspond to the shape of the hose 12 (e.g., generally cylindrical). Each of the first and second portions 116, 118 includes a raised portion indicated by the references 117 and 119 respectively. As described in more detail below, when the strap 100 is secured about the circumference of a hose, the raised portion 117 may be used to receive excess cover while the raised portion 119 may be used to receive excess belt.

The first and second portions 116, 118 each include a pair of side openings or slots 122, 124 on opposite sides thereof. The side openings 122, 124 extend transversely of the belt 104 and are sized and configured for receiving the belt 104. A tab 128 is provided in the central portion of the first portion 116. The tab 128 is formed of a resilient material allowing it to be depressed or pulled by a user of the strap 100. In the shown embodiment, the tab 128 is formed integral with the strap 100. After the strap 100 has been releasably secured to a hose, lifting or pressing the tab 128, depending on the particular embodiment, allows the belt 104 of the strap 100 to be released.

A foldable support 132 is connected to the main portion 106 along an integral hinge 133. The top surface of the support 132 includes a plurality of spaced apart first projections 134 for engaging the locking projections 110 of the belt 104. The support 132 also includes a first connector 136 for releasably engaging a second connector 138 located on the first portion 116 of the main portion 106. As shown in FIG. 12 to 15, the first and second connectors 136 and 138 may comprise a pair of mating press-fit connectors. In other embodiments, other types of mating connectors may be used. In some embodiments, the first projections 134 may be provided on the bottom (inner) surface of the first portion 116 rather than by way of foldable support.

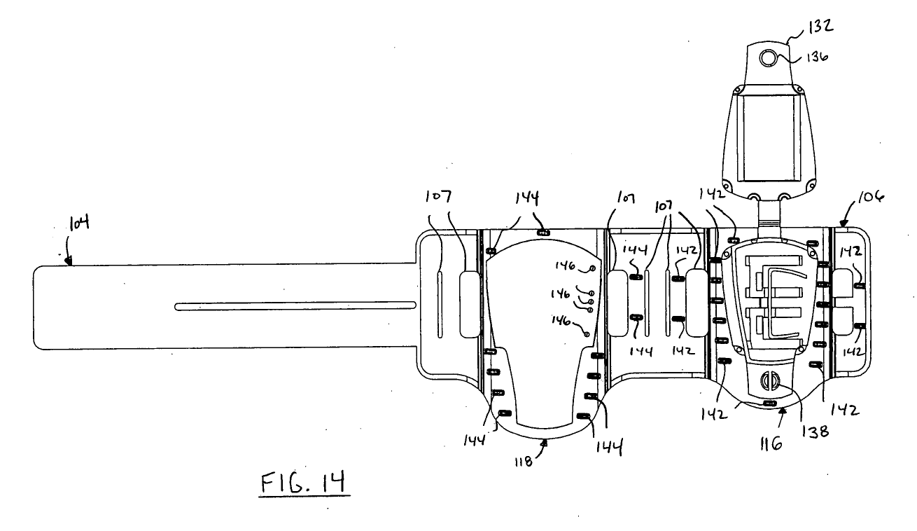

As shown in FIG. 14, the bottom or inner surface of the strap 100 includes a plurality of second projections 142, 144 located about the periphery of the first and second portions 116, 118 respectively. The second projections 142, 144 are located to correspond in orientation to the profile of the hose, for example the corrugations in a central vacuum hose 12. The second projections 142, 144 are adapted to engage or bite into the fabric of the cover 10 and into the recesses and/or corrugations of the hose 12 for effective gripping. The arrangement of the second projections 142, 144 may be varied to suit the particular profile of the type of hose with which the strap 100 is to be used. The bottom surface of the second portion 118 may also include a plurality of third projections 146 for engaging the holes 114 defined in the outer portion 112 of the belt 104.

Portions 127, 129 of the top surface of the first and second portions 116, 118 may be used to receive various indicia such as a product or brand name. The indicia may be provided by way of an insert mold attached to the top surface, or received in or on the top surface, for example in a recess. In other embodiments, the indicia may be provided by labels adhered to the top surface. In the shown embodiment, the portions 127, 129 are located in a generally central portion of the first and second portions 116, 118. In some embodiments, the portions 127, 129 of the top surface of each of the first and second portions are recessed, as shown in FIGS. 12 to 15.

The projections 110, 134, 142, 144 and 146 may be projections, protrusions, protuberances, teeth, ridges or other type of engaging member. The shape and arrangement of the projections 110, 134, 142, 144 and 146 may be varied from that shown in FIGS. 12 to 15 provided the projections are capable of performing the required engaging functions described above.

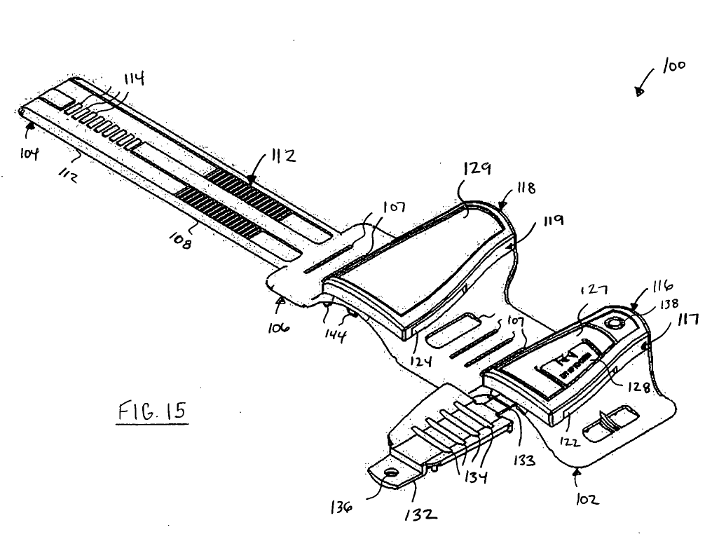

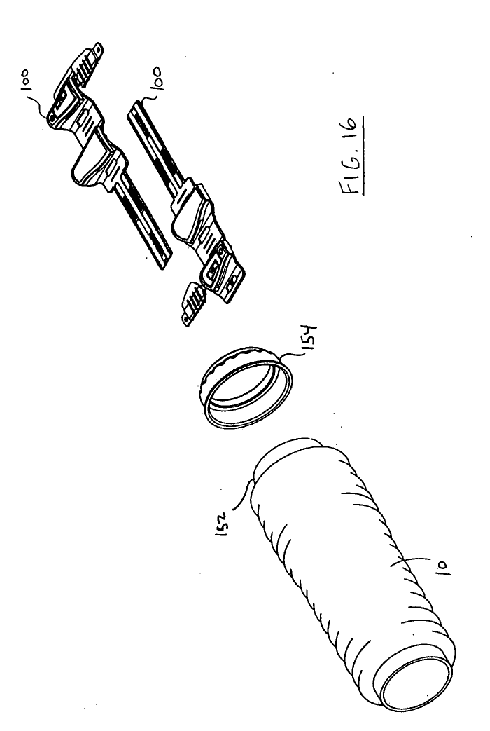

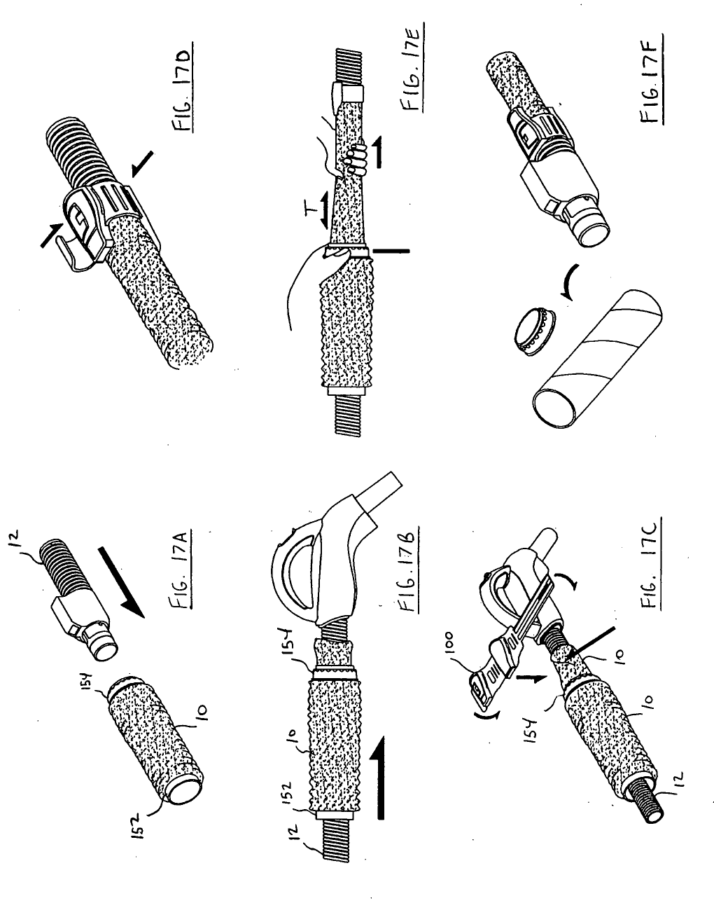

Referring now to FIG. 16 to 17F, one exemplary method of installing a cover about a hose 12 using the strap 100 will be described. In a typical installation, the user is provided with a cover such as a stretchable fabric cover 10 pre-installed on an installation tube 152, an installation guide 154, and a pair of straps 100 for securing the cover 10 to the respective ends of the hose 12. The installation tube 152 has an inner diameter which is larger than the outer diameter of the hose 12 so that it can be easily fit over the hose 12. In some embodiments, the installation tube 152 has an inner diameter of approximately 3″ and a length of approximately 12″, whereas the hose 12 has an outer diameter of approximately 1¼ to 1½″. The installation guide 154 is sized to fit loosely over the cover 10 at one end of the installation tube 152 and is provided with a flange which defines an opening sized and configured to apply a relatively constant tension to the cover 10 as it is being installed over the hose 12. The installation guide 154 may be made from plastic and may be formed by injection molding.

In the first step of the installation method, the installation guide 154 is fit over one end of the cover 10 on the installation tube 152 such that a portion of the cover 10 extends through the opening in the guide 154. Next, the plug end of the hose 12 is inserted into the tube 152 (FIG. 17A). In the next step, the tube 152 is slid or pushed along the length of the hose 12 towards the handle end of the hose 12 (FIG. 17B).

As shown in FIG. 17C, in the next step the end of the cover 10 may be folded over onto itself to take up any excess cover material. This step is optional and may not be necessary or desirable in some applications. One of the straps 100 is then positioned over the end of the cover 10. The strap 100 is then wrapped about the circumference of the hose 12 and cover 10. The excess cover material may be received in the raised portion 117 of the first portion 116.

Next, as shown in FIG. 17D, the outer portion 112 of the belt 104 is inserted through the side openings 122 of the first portion 116. The strap 100 is then pulled through the openings 122 until the strap 100 has been sufficiently secured about the circumference of the hose 12. As the outer portion 112 is pulled through the side openings 122, the projections 134 of the support 132 engage the projections 110 of the belt 104 releasably securing the belt 104 therein. In this position, the projections 142, 144 of the first and second portions 116, 118 engage the corrugations in the hose 12, assisting in securing the strap 100 to the hose 12. In some embodiments, the tension applied by the strap 100 by itself may be sufficient to secure the cover 10 to the hose 12.

As shown in FIG. 17D, in the next step, excess belt 104 is inserted through the side openings 124 of the second portion 118. The excess belt 104 may be received in the raised portion 119 of the second portion 118. In this position, the projections 146 of the second portion 118 engage the slots 114 in the belt 104, assisting in releasably securing the belt 104 therein.

As shown in FIG. 17E, in the next step, while holding the installation guide 154, the handle end of the hose 12 is pulled towards the user until the plug end of the hose 12 is reached. This allows a relatively constant tension (T) to be applied to the cover 10, facilitating installation of the cover 10 to the hose 12.

As shown in FIG. 17F, when the plug end of the hose 12 is reached, the end of cover 10 may be folded over onto itself to take up any excess material. Next, the second strap 100 is positioned over the end of the cover 10. The strap 100 is then wrapped about the circumference of the hose 12 and cover 10. The belt 104 is then releasably secured as described above. The installation tube 152 and guide 154 may be then discarded or stored for future use.

The adjustable strap of the present invention, in some embodiments, provides multiple locking positions to accommodate multiple hose diameters. The locking features of the strap are also releasable providing ease of removal of the cover 10. In some embodiments, the strap provides a racketing action for securing the strap to the hose, simplifying the installation process. In these embodiments, the adjustable straps function as removable ratcheting straps. The adjustable strap of the present invention may be used with different types of covers, including stretchable hose covers, non-stretchable hose covers, fabric and non-fabric hose covers. In some embodiments, the adjustable strap may be used with different types of hoses and cords, including corrugated and non-corrugated hoses and cords.

In some embodiments, the stretchable fabric cover 10 will stretch both in length and diameter to accommodate at least 32 mm and 35 mm hose sizes. Furthermore, in some embodiments the longitudinal elasticity of the cover 10 allows one length of cover to be used for different hose lengths, such as 30 ft and 35 ft hoses.

Although the elasticity of the stretchable fabric cover of the present invention allows the cover to be stretched in length and diameter to accommodate various hose dimensions, there remains an operating range for the covers. Above this operating range overstretching of the cover may occur, resulting in a loss of performance. The operating range of a covers depends on a variety of factors including the amount of elastic fibers it contains.

The features of present invention may be modified for use with hoses of varying diameters and lengths. For example, the present invention may be used with central vacuum systems having long vacuum hoses, typically 1¼ to 1⅜ inches in diameter and 30 to 35 ft in length, and industrial or “shop” vacuums which typically have shorter hoses with larger diameters. It will also be appreciated by persons skilled in the art that the present invention is not limited to vacuum hoses, but may also be used for covering other types of hoses, cords (e.g. electrical cords) and the like.

Although the present invention has been described with reference to illustrative embodiments, it is to be understood that the invention is not limited to these precise embodiments, and that various changes and modifications may be effected therein by one skilled in the art. All such changes and modifications are intended to be encompassed in the appended claims.

1. A stretchable fabric cover for a hose, comprising:
a tubular member formed of a non-abrasive fabric being open at opposite ends thereof, the non-abrasive fabric including elastic fibers allowing lateral and longitudinal stretching of the tubular member in response to a corresponding lateral or longitudinal stretching force.

2. The cover as claimed in claim 1, wherein the tubular member has a relaxed state in which no stretching force is applied thereto, the tubular member having a diameter less than the diameter of the hose when in its relaxed state so that when a lateral stretching force is applied to the cover, the cover can be fit over the hose, and when the lateral stretching force is released the cover snuggly fits the hose.

3. The cover as claimed in claim 2, wherein the tubular member has a length less than the length of the hose when in its relaxed state so that when a longitudinal stretching force is applied to the cover, the cover can be stretched to opposite ends of the hose and secured thereto while the elastic fibers retain sufficient elasticity for further longitudinal stretching of the tubular member.

4. The cover as claimed in claim 1, wherein the non-abrasive fabric comprises a fabric surface and a plurality of terry loops extending from the fabric surface.

5. The cover as claimed in claim 1, wherein the non-abrasive fabric comprises a terry knit fabric.

6. The cover as claimed in claim 1, wherein the non-abrasive fabric comprises at least 5 percent elastic fibers by weight.

7. The cover as claimed in claim 1, wherein the non-abrasive fabric comprises between 5 percent and 30 percent elastic fibers by weight.

8. The cover as claimed in claim 1, wherein the elastic fibers are fibers selected from the group consisting of Lycra fibers.

9. The cover as claimed in claim 1, further comprising securing means for releasably securing the cover to the hose at the opposite ends thereof.

10. In combination with a stretchable fabric cover for a hose, a strap for securing the cover to the hose, the strap comprising:
an elongate flexible member for wrapping about a circumference of the hose, the flexible member including a belt and an adjacent main portion for releasably securing the belt therein, the belt having an inner portion and an outer portion adjacent to the inner portion, the inner portion including a plurality of spaced apart locking projections, an inner surface of the main portion including a plurality of spaced apart first projections for releasably engaging the locking projections of the belt.

11. The strap as claimed in claim 10, wherein the elongate flexible member defines a plurality of slots, the slots being sized and arranged to increase the flexibility of the belt.

12. The strap as claimed in claim 10, wherein the main portion includes enlarged, outwardly extending first and second portions, the first and second portions being shaped to generally correspond to the shape of the circumference of the hose.

13. The strap as claimed in claim 12, wherein the first and second portions of the main portion each include a portion for receiving excess cover and excess belt respectively.

14. The strap as claimed in claim 12, wherein the first and second portions of the main portion each include a pair of side openings on opposite sides thereof, the side openings extending transversely of the belt and being sized and configured for receiving the belt when wrapped about the circumference of the hose.

15. The strap as claimed in claim 10, further comprising a foldable support connected to the main portion along an integral hinge, the foldable support extending transversely of the belt, the first projections being provided on a surface of the foldable support such that when folded about the integral hinge, the first projections are provided on the inner surface of the main portion.

16. The strap as claimed in claim 15, further comprising a tab provided in a central portion of the first portion, the tab cooperating with the foldable support such that the belt may be released from the main portion by depressing or pulling the tab.

17. The strap as claimed in claim 16, wherein the tab cooperates with the foldable support such that the locking projections of the belt are released from the first projections provided on the foldable support by depressing or pulling the tab.

18. The strap as claimed in claim 15, wherein the foldable support includes a first connector for releasably engaging a second connector located on the first portion of the main portion.

19. The strap as claimed in claim 11, wherein the inner surface of the elongate flexible member includes a plurality of second projections located about the periphery of the first and second portions, the second projections being located to correspond in orientation to a profile of the hose.

20. The strap as claimed in claim 10, wherein the outer portion of the belt defines a plurality of spaced apart slots, the inner surface of the second portion of the main portion including a plurality of third projections for engaging the slots defined in the outer portion of the belt.

21. A method for securing a tubular cover to a hose, the cover being made of a stretchable fabric and being open at opposite ends thereof, comprising the steps of:
applying a lateral stretching force to one end of the cover to enlarge its diameter so as to be larger than the diameter of the hose;
introducing the hose into the enlarged end of the cover; and
aligning the opposite ends of the cover with the respective ends of the hose; and
securing the opposite ends of the cover to the hose.

22. The method as claimed in claim 21, wherein the step of aligning the opposite ends of the cover includes the step of applying a longitudinal stretching force to the cover to increase the length of the cover so that its ends are aligned with the opposite ends of the hose.

23. The method as claimed in claim 22, wherein the step of securing the opposite ends of the cover comprises the step of:
securing the cover within recesses defined in the hose near the opposite ends of the hose.

24. The method as claimed in claim 23, wherein the cover is secured within recesses defined by corrugations in the hose.
